(19) United States
(12) Patent Application Publication
(10) Pub. No.: US 2017/0234906 A1
(43) Pub. Date: Aug. 17, 2017

(54) DEVICE, SYSTEM, AND METHOD FOR ORIENTING AN ACCELEROMETER

(71) Applicant: Novatel Wireless, Inc., San Diego, CA (US)

(72) Inventors: Charles Moore, Plano, TX (US); Arthur W. Kockritz, The Colony, TX (US); Steve Michael Bogandoff, Allen, TX (US)

(21) Appl. No.: 15/335,016

(22) Filed: Oct. 26, 2016

Related U.S. Application Data
(60) Provisional application No. 62/246,560, filed on Oct. 26, 2015.

(51) Int. Cl. G01P 21/00; G01C 19/56

(52) U.S. Cl. CPC G01P 21/00; G01C 19/56

(57) ABSTRACT

Methods, systems and devices for installing, configuring and orienting an accelerometer device into an application in which the orientation of the accelerometer device is arbitrary are disclosed herein.

### BACKGROUND

The present invention relates generally to the field of accelerometers and more particularly to orientation of accelerometers after they are installed in a product.

Accelerometers are typically electromechanical devices which measure acceleration forces. These forces may be static, like the constant force of gravity pulling objects toward the earth's core, or they could be dynamic, such as forces caused by moving or vibrating the accelerometer. By measuring the amount of static acceleration due to gravity, it is possible to find out the angle at which an accelerometer may be tilted with respect to the earth. By sensing the amount of dynamic acceleration, it is possible to analyze the way an accelerator may be moving.

There are many different ways in which an accelerometer may work. Generally speaking, accelerometers are configured to produce a voltage indicative of accelerative forces being exerted on the device. For example, some accelerometers use a piezoelectric effect. These type of accelerometers usually contain microscopic crystal structures that get stressed by accelerative forces, which causes a voltage to be generated. Another type of accelerometer may sense the changes in capacitance between two microstructures next to each other. In these type of accelerometers, the microstructures have a certain capacitance between them. If an accelerative force moves one of the structures, then the capacitance between the structures will change. Additional circuitry which converts the capacitance to a voltage is typically included to produce a voltage indicative of the sensed accelerative forces. Other sample accelerometers may use piesoresistive effects, magnetoresistive effect, Hall Effect, heat transfer effect, or other means for measuring the accelerative forces being placed on the accelerometer.

Accelerometers allow a user to understand the surrounding of an item better. For example, an accelerometer can determine the angle at which a device is tilted with respect to the Earth, or determine whether an object is moving uphill, whether it will fall over if it tilts any more, or whether it is flying horizontally or angling downward. Accelerometers have many different applications. For example, smartphones use accelerometer to detect the tilt of the smartphone to determine whether to rotate their display between portrait and landscape mode depending on how you tilt the phone. Accelerometers can also be used in laptop computers to protect hard drives from damage. If a laptop were to suddenly drop while in use, the accelerometer can detect the sudden free fall and immediately turn off the hard drive to avoid hitting the reading head into the hard drive platter. Without this, the two would likely strike and cause scratches to the platter which would, most likely, cause extensive file and reading damage. Accelerometers can likewise be used in cars as the industry method way of detecting car crashes and deploying airbags almost instantaneously.

In order for accelerometers to provide useful data, the orientation of the device must be known. In some applications, the orientation is known at installation or the device is manually oriented at installation. However, since accelerometers and/or devices incorporating accelerometers are often times installed in arbitrary orientations, they typically must be “oriented” once they are installed into a device to function properly. Existing accelerometers require an installation procedure be performed or a significant amount of “training time” is required before the accelerometer functions properly in the application. For example, some early accelerometer applications for use in a moving vehicle, required that the vehicle be driven in a specific pattern in order to properly orient the accelerometer. Other, more recent applications used whatever accelerometer and vehicle data that was available, however, the “training times” for orienting these devices was objectionable (on the order of 4-6 hours of driving).

### SUMMARY

One embodiment of the invention relates to orienting an accelerometer by properly filtering accelerometer data, selecting accelerometer/OBD data for vertical alignment, selecting accelerometer/OBD data for horizontal alignment, calculating an alignment matrix, calculating an RMS deviation of the alignment matrix to determine accuracy of alignment, using the aligned data to determine driver behavior (braking, turning, accelerating, . . . ), sending the aligned or maligned data, with or without alignment accuracy to a server application on a periodic basis, or upon detection of specified driver behavior, and continuously monitoring and fine tuning the alignment matrix based upon ongoing measurements.

Another embodiment of the invention relates to a method for orienting an accelerometer by using accelerometer data for calculations, using permutations of OBD, GPA, accelerometer and gyro data to qualify data for use in determining orientation, calculating vertical alignment based upon long term averages of a gravity vector, calculating lateral alignment based upon sample collected during straight line acceleration and deceleration, creating a rotation matrix based upon alignment buffers, determining the quality of alignment by monitoring variation in the rotation matrix, and using aligned data if the matrix quality is above a configurable threshold.

Still another embodiment of the invention relates to a method for orienting an accelerometer for a driver behavior device by inserting accelerometer data in a lateral data buffer in order to determine a gravity vector based upon information from any one or more of the following: inserting data in a vertical data buffer, based upon information from any one or more of the following: GPS heading change of less than a configurable amount; GPS speed change of greater than a configurable amount; OBD speed change of greater than a configurable amount; and/or gyro rotation of less than a configurable amount; calculating a rotation matrix based upon the data stored in the lateral and vertical data buffers; calculating a deviation of the rotation matrix, and if deviation is less than a configurable amount, allowing driver behavior monitoring.

### BRIEF DESCRIPTION OF THE DRAWINGS

FIG. 1 is a flow chart illustrating one embodiment of the invention;

FIG. 2 is a flow chart illustrating another embodiment of the invention

### DETAILED DESCRIPTION OF THE PREFERRED EMBODIMENTS

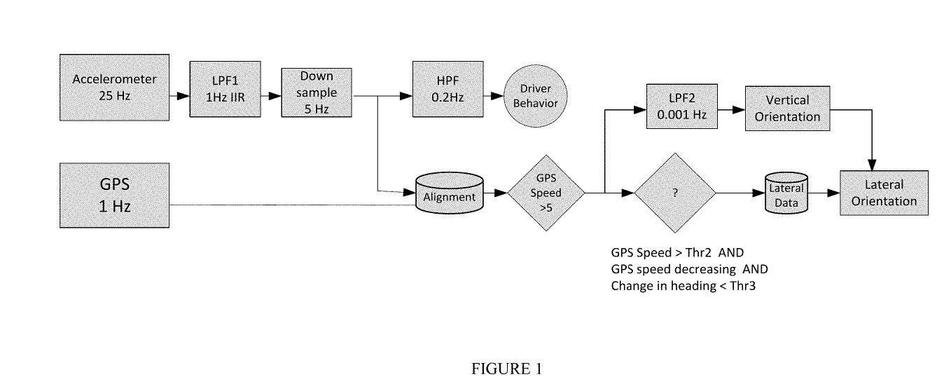

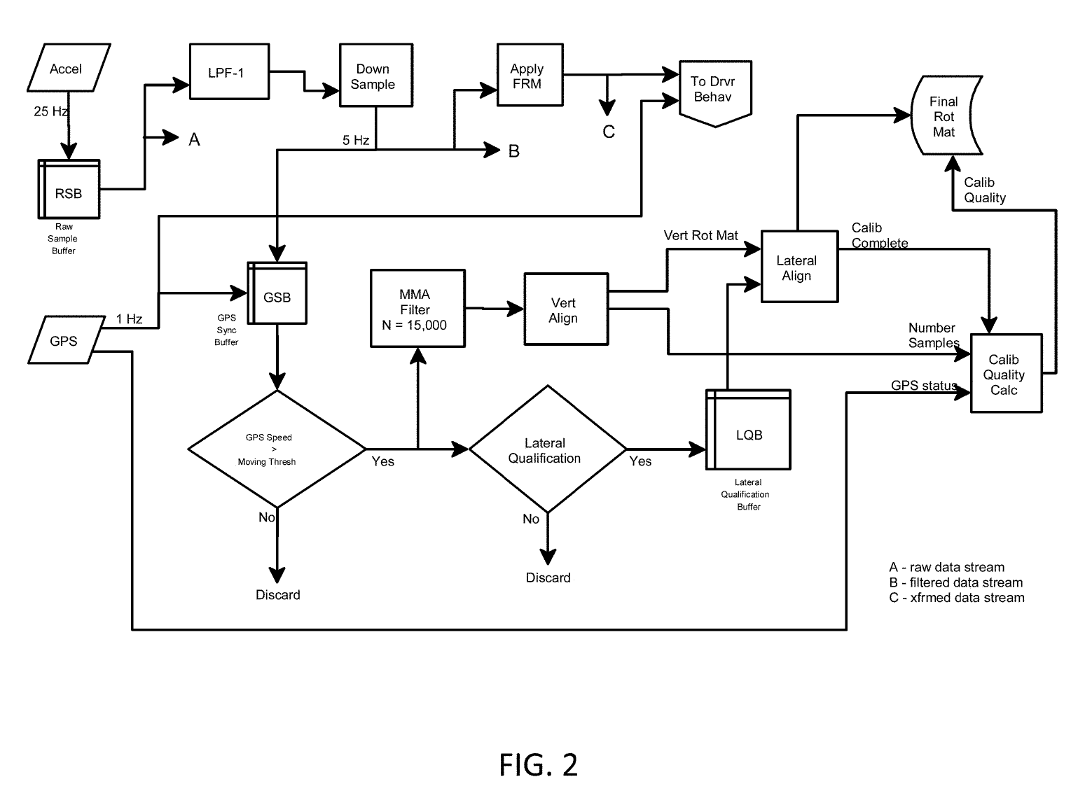

Referring now to FIGS. 1 and 2, sample embodiments of the invention are described herein. FIG. 1 illustrates a first phase of an embodiment of a method for installing, configuring, and orienting an accelerometer according to the present invention. FIG. 2 illustrates a second phase of an embodiment of a method for installing, configuring, and orienting an accelerometer according to the present invention.

In one embodiment, the components illustrated in FIGS. 1 and 2 can comprise the following: RSB can be a simple data buffer. LPF-1 can be a 4 pole elliptical filter with a 10 second training sequence. Down sampling can be a simple discarding of data. GSB can be a GPS Synchronization Buffer (GSB), aligning GPS data with accelerometer data. GPS Speed decision can be based on speed being in excess of 2.5 mph for 2 seconds before current sample, all 3 samples being valid (Nw_autocal_qualify_for_vert_align). Lateral Qualification can be based on: Delta speed>80% of dynArcThresh (125 mg) and Delta heading<1.5 degrees. The Autocal_add_to_lqb function can place data into the Lateral Qualification Buffer (LQB). The Autocal_process_lqb function can process samples in the LQB to determine an xy vector. The MMA Filter can be a Modified Moving Average (MMA) filer with: Avg=(((size-1) * PrevAvg)+sample)/size), where size=15,000 for one embodiment and 30,000 for another embodiment. The LQB can be configured to store data from Lateral Qualification. Vert Align can calculate Z axis vectors (Autocal_calc_z_rot_matrix). Lateral Align can calculate XY vectors (Autocal_calc_xy_rot_matrix). Final Rot Matrix can calculate the final rotation matrix (Autocal_calc_g_rot_matrix). Calib Quality Calc can provide a quality indication (in one embodiment, 80% based on MMA sample count, 20% from LQB count). Autocal_set_status In one embodiment, on startup, the MMA buffer fills with 5000 samples before the first Vert Align is attempted, and LQB fills with 50 samples before the first Lateral Align is attempted. Vert/Lateral Align can be calculated every 6000 samples. For one embodiment, the 25 Hz accel becomes a 100 Hz accel data and the 5 Hz down sample becomes a 10 Hz. Filters can also be modified accordingly.

The Calibration Quality Factor (CQF) can be calculated from: lateral alignment completed; number of samples incorporated into vertical processing; number of samples incorporated into lateral processing; and GPS fix. The CQF can be copied into a user variable (system variable −867). The CQF threshold can be set with the AT command AT$ACCCQF. The CQF scale can be 0 to 100, with a minimum threshold setting of 25. The accelerometer bandwidth can be fixed at 7.81 Hz. The parameter in the $ACCCFG command for bandwidth does not affect the accelerometer setting. Preferably, the sample rate should not be changed from the default 25 Hz. The calibration count can still be available as a system variable (−866). The calibration count can start at 0 after a power cycle of the unit, and can increment each time a orientation calibration calculation is completed.

The AT command can be set to the CQF threshold for event generation. AT$ACCCQF=<min-cqf>, with min-cqf=25-100, sets the minimum CQF that must be reached before accelerometer output events will be generated. AT$ACCCQF?, $ACCCQF: 50, 0, can show the current CQF threshold setting and the current calculated CQF. AT$ACCCQF=?, with $ACCCQF: (25-100), can show the allowed range of CQF threshold settings.

Some of the $ACCDBG commands have changed. The following AT commands have been removed: AT$ACCMGC, AT$MGCCFG, AT$ACCRC, and AT$ACCORN. The following AT commands have been modified: AT$ACCFLT—the coefficient parameter is no longer used; AT$ACCCFG—the bandwidth parameter is not used, instead it is fixed internally at 7.81 Hz; AT$AUTOCFG—the static cal seconds, the dynamic cal hysteresis, and the cal direction parameters are no longer used, the min samples (2^{nd} parameter) has a new range (25-100) and a new default (50); and AT$ACCSAM—the coef parameter is no longer used.

Referring now to the FIGS. A=raw data stream, B=filtered data stream, and C=xfmed data stream.

Accelerometer Input and LPF-1

Currently, the accelerometer is read at 25 Hz (40 msec) by the accel timer function nw_accel_timer_handler( ). Samples can be scaled to mG and put into the circular Raw Sample Buffer (RSB). This buffer can allow the accelerometer reading to synchronize with the lower rate filtering process. A timestamp can be saved for each sample as it is read from the hardware. This functionality will not be changed. The low pass filter LPF-1 can be a 4-pole elliptical filter. This filter can have a training period at system reset that can be approximately 10 seconds. Each axis can have a separate filter. The downsample block can output one value for every 5 input values which can result in a data rate of 5 Hz. The output of the down sampling can be sent to the GPS Sync Buffer (GSB). A timestamp can be maintained for the samples set to the GSB.

GPS and Accelerometer Sync

The output of the accelerometer low pass filtering and data down sampling process can be input to the GSB at 5 Hz. The GPS reports can be received at 1 Hz. GPS can have a 2D or 3D fix before GPS or accel samples are put into the GSB. There can be 4 to 6 accel samples between GPS reports. This buffer can hold at least 5 seconds of GPS and accel reports. This buffer generally does not need to be saved over a reset; it can be refilled during the training period of LPF1 which can be about 10 seconds. For a sample alignment, a timestamp similar to the accel samples can be saved for the GPS reports.

Apply Final Rotation Matrix/Driver Behavior

This block can apply the Final Rotation Matrix (FRM) to the output of the downsampling. If the FRM has not been calculated, the accelerometer data will not be passed to the Driver Behavior processing, or will be marked as invalid. The CQF can be passed to Driver Behavior to allow events to be supporessed based on the quality factor. The quality factor threshold can be user adjustable by an AT command. The Driver Behavior can be basically unchanged in functionality from the existing code, however there could be changes to allow it to interface with the new functionality. Samples set to Driver Behavior can have a timestamp with them to allow the event duration to be calculated from the time difference of the event start and end. GPS information for each sample can also be passed to Driver Behavior.

GPS Speed >Moving Threshold

This block can allow the accelerometer samples to be qualified for use in the orientation calibration. An acceleration sample can be qualified for use in calibration processing if the two GPS reports before it and one GPS report after it have a speed value greater than the moving speed threshold. In one embodiment, this threshold can be set at 5 MPH (4.3 knots). The samples that pass this check can be passed to LPF-2 for use in the vertical rotation matrix calculation and can be passed to the lateral qualification check.

Low Pass Filter 2

Accel samples that pass the moving threshold can be incorporated into the LPF-2. A count of the number of samples incorporated can also be kept. Periodically, the states of this filter can be saved, along with the sample count. This info can be used to re-initialize the filter to the previous state upon reset. On a power-up reset, the saved filter state is not used. The LPF-2 can include the following functions: initialize filter state; restore filter state; filter function; and save filter state function.

Lateral Qualification

Lateral qualification can be used to qualify samples to be used for lateral alignment. The criteria for this qualification can be: GPS speed>Threshold (lateral speed); GPS speed decreasing (delta speed>Threshold (delta speed); and change in GPS heading<Threshold (lateral heading). If all of these criteria are true for the two GPS reports before the accel sample and the one GPS report after the accel sample, the accel sample can be qualified and put into the Lateral Qualification Buffer (LQB).

Lateral Qualification Buffer

The LQB can hold accel samples (x,y,z) that have passed the lateral qualification. It can hold these samples until it is re-initialized or until the buffer fills, in which case old samples can be discarded. In one embodiment, the buffer length can be 250 samples. Periodically, the values in this buffer can be saved along with the sample count. This info can be used to re-initialize the buffer to the previous state upon reset. On a power-up reset, the saved buffer info is not used. The LQB can use the following functions: initialize buffer function; restore buffer and sample count function; and save buffer and sample count function.

Vertical Alignment Calculation

When the number of samples in the LPF-1 reaches a predetermined threshold, for example 1500 samples which corresponds to 5 minutes of moving samples a a 5 Hz down sampling rate, the Vertical Rotation Matrix (VRM) can be calculated using the output of LPF-2 for the x, y, and z values. When the vertical matrix is calculated, lateral alignment will be enabled. After the initial VRM calculation, recalculation of the VRM can be done with the number of samples added to LPF-2 since the last VRM calculation reaches a predetermined threshold, for example 1500 samples. When the VRM is recalculated, the lateral alignment can also be recalculated.

Lateral Alignment Calculation

Lateral alignment calculation can be done with enabled and when the number of samples in the Lateral Quality Buffer (LQB) is greater than a predetermined threshold, for example 50 samples. The lateral alignment calculation can be made as follows: rotating all samples in the LQB by the current VRM (this will put the x and y values to the vehicle's horizontal plane); for samples with XYmag>Threshold (lateral accel), the x and y values can be added together to a sum for each of the x and y coordinate pairs—a sample count can be kept for all samples that pass this criteria; if the sample count does not meet a minimum threshold value, the LRM will not be calculated (insufficient samples); the average for x and y can be calculated and the average values can be used to calculate the Lateral Rotation Matrix (LRM) by multiplying the VRM by the LRM to obtain a Final Rotation Matrix (FRM); and when the FRM is calculated, it can be saved for reloading at non-power-up resets. When the VRM is recalculated, or when M additional samples have been added to the LQB since the last LRM was generated, the LRM can be recalculated.

Calibration Quality Calculation

The Califration Quality Factor (CGF) can be calculated from: lateral alignment completed, number of samples incorporated into LPF-2, number of samples qualified for the LQB, and a GPS fix. The CQF can be available to be sent as a user variable. When the CQF is below a user settable threshold, accelerometer events can be suppressed. In one embodiment, the CQF scale can be 0-100.

Final Rotation Matrix

The Final Rotation Matrix (FRM) can be saved when it is calculated, along with the factores from the vertical and lateral alignment calculation used to generate the FRM. The FRM can be restored from the last saved value (if valid) on a non-power-up reset condition. The FRM can be loadable by a debug AT command with the previously saved value.

Additional features in future phases of implementation can include: accepting acceleration data from on-board diagnostics (OBD) when GPS is not available; the Calib Quality Calc can be changed to be a Root-Mean-Square (RMS) delta of G vector; the LQB thresholdcan be lowered from 50 to 30; the MMA threshold can be lowered from 5000 to 2500; and/or the vectors can be calculated every 2000 samples instead of 6000 samples

A sample G matrix might be structured as follows:

| | | | |
|---|---|---|---|
| MATG[0][0-2]: | 0.367 | 0.9297 | −0.0312 |
| MATG[1][0-2]: | 0.9297 | −0.3655 | 0.0458 |
| MATG[2][0-2]: | 0.0312 | −0.0458 | −0.9985 |
| MATG[0][0-2]: | 0.367 | 0.9297 | −0.0312 |
| MATG[1][0-2]: | 0.9297 | −0.3655 | 0.0458 |
| MATG[2][0-2]: | 0.0312 | −0.0458 | −0.9985 |

In one embodiment, proposed calculation can be:

SQRT((MATGOld[0][0]−MATG[0][0])**2+(MATGOld[0][1]−MATG[0][1])**2)+. . .

This can provide a number between 0 and 1, and can be considered a percentage. This percentage can be available for export, and could be used for determination of calibration. In one embodiment, calibration is acceptable when the percentage is less than 5% for 5 consecutive calculations.

A method of calculating the auto calibration quality factor (CQF) may include: 1) accepting the acceleration data from OBD when GPS is not available. This helps in populating the MMA count but should not affect the LQB count. However, GPS data is still helpful to determine that the accelerometer is heading in straight path.

2) The CQF could be based on the RMS delta of the gravity vector and it could scale by the LQB. An LQB of 30 or greater could scale the CQF to 100% and minimum LQB of 5 could scale CQF to 50%.

3) The LQB threshold could be lowered from 50 to 30. As stated in 2, an LQB of 5 to 30 scales CQF by 50% to 100% 4) Lower MMA threshold from 5000 to 2500. The first 1000 samples now only requires ignition (can be parked). Calculate the vectors every 1000 for the first 5 periods.

5) Calculate vectors every 2000 samples instead of 6000 samples. The first 5 periods are calculated at 1000 samples and the steady state period is 2000 samples.

In still another possible future implementation phase. A gyro and gyro data may be used. In this implementation, two areas can be modified with Gyro data.

1. Lateral Qualification can be based on:
a. Delta speed>80% of dynArcThresh (125 mg) and
b. Delta heading<1.5 degrees OR Oriented Gyro<×deg/sec.
c. Autocal_add_to_lqb places data into lqb
d. Autocal_process_lqb processes samples in the LQB to determine xy vector.

In the presence of GPS, there might only be negligible improvement. However, in the absence of GPS, this method could provide about the same convergence rate as with functioning GPS data.

Some Sample Commands
Reading Matrix Data

Matrix data can be available through query, and in tests was read every 10 minutes.

MATG[0:2] presents a 3×3 Vertical Alignment vector, each value containing 3 numbers.

MATZ[0:2] presents a 3×3 Lateral Alignment vector.

MAT[0:2] presents a final 3×3 rotation matrix.

MATI[0:2] presents an integer form of MAT>

1.1 Enabling Streaming

The ACCDBG message can enable the streaming of PNWAC data. For example, with the command AT$ACCDBG=211,X
X can be a bitmask:
X desc
1 enable raw data stream
2 enable LPFI data stream
4 enable transformed data stream
8 enable LPF2 (MMA) and cal data stream
X=15 will enable all the data streams together

1.2 PNWAD Data

$PNWAD can present a calibration status. In tests it was sampled at 10 minute intervals.

Param desc

1 cal state (4=lateral complete, 2=vertical complete)
2 cal count (number of times the lateral has completed, resets to 0 on power up reset)
3 vertical average X
4 vertical average Y
5 vertical average Z
6 lateral sum of X
7 lateral sum of Y
8 lateral sample count

EX: $PNWAD,2,0,-111,-342,-920,0,0,0

$PNWAD,4,1,-111,-334,-922,6332,-8114,50

Vertical calibration complete, lateral not complete, X vert avg from MMA is −111, Y vert avg from MMA is −342, Z vert avg from MMA is −920, and lateral data not provided.

Lateral calibration complete, X vert avg from MMA is −111, Y vert avg from MMA is −334, Z vert avg from MMA is −922, and lateral sum of X, Y and Z are 6332, −8114 and 50 respectively.

1.3 PNWAC Data

$PNWAC can provide samples of raw data at various points of the processing. Samples can occur at the down sampled rate. Samples can be provided at 4 points:
1. Raw data at the accelerometer clock rate. Data is provided at the down sampled rate, with the appropriate number of data samples at the higher data rate. For example, one embodiment can have a 5 Hz rate, and have 5 messages per second. Raw data at 25 Hz means that 5 sets of data pare presented in each message.
2. Filtered, from LPF1, provides filtered and down sampled data, one sample per message, messages generated at the down sample rate.
3. Transformed provides data as presented to the driver behavior analysis.
4. LPF2 provides data from the MMA filter at a 1 Hz sample rate.

Param desc
1 stream # (0=raw, 1=filtered, 2=xformed, 3=LPF2 output)
2 #msec from previous sample
3 X
4 Y
5 Z

Params 2 through 5 repeat 4 more times for the raw stream EX:

$PNWAC,0,40,-117,-352,-945,40,-117,-359,-961.40,-117,-359,-961,40,-109,-344,-914,40,-117,-352,-906

Raw Stream contains samples every 40 ms, with X, Y and Z data provided for each sample, 5 samples per 200 ms.

$PNWAC,1,200,-120,-352,-935

LPF1 provides 200 ms samples with a single X/Y/Z data presentation

$PNWAC,2,200,11,3,1006

Transformed, the data appears to be aligned with gravity at 0/0/1000

$PNWAC,3,201,-111,-334,-922

The output of the MMA filter is also at 200 ms with a more filtered version of the LPF1 data.

1.4 GPS Messages

$GPRMC

Recommended minimum specific GPS/Transit data

eg1. $GPRMC,081836,A,3751.65,S,14507.36,E,000.0,360.0,130998,011.3,E*62

eg2. $GPRMC,225446,A,4916.45,N,12311.12,W,000.5,054.7,191194,020.3,E*68
225446 Time of fix 22:54:46 UTC
A Navigation receiver warning A=OK, V=warning
4916.45,N Latitude 49 deg. 16.45 min North
12311.12,W Longitude 123 deg. 11.12 min West
000.5 Speed over ground, Knots
054.7 Course Made Good, True
191194 Date of fix 19 Nov. 1994
020.3,E Magnetic variation 20.3 deg East
*68 mandatory checksum

$GPGSA

GPS DOP and active satellites

eg1. $GPGSA,A,3, , , , 16,18,22,24, , . 3.6,2.1,2.2*3C

eg2. $GPGSA,A,3,19,28,14,18,27,22,31,39, , , 1.7,1.0,1.3*35

1=Mode:
M=Manual, forced to operate in 2D or 3D
A=Automatic, 3D/2D

2=Mode:
1=Fix not available
2=2D
3=3D

3-14=IDs of SVs used in position fix (null for mused fields)

15=PDOP

16=HDOP

17=VDOP

$GPGGA-essential fix data which provides 3D location and accuracy data.

$GPGGA,123519,4807.038,N,01131.000,E,1,08,0.9,545.4,M,46.9,M, , , *47

Where:

GGA Global Positioning System Fix Data

123519 Fix taken at 12:35:19 UTC

4807.038,N Latitude 48 deg 07.038′ N

01131.000,E Longitude 11 deg 31.000′ E

1 Fix quality: 0=invalid
1=GPS fix (SPS)
2=DGPS fix
3=PPS fix
4=Real Time Kinematic
5=Float RTK
6=estimated (dead reckoning) (2.3 feature)
7=Manual input mode
8=Simulation mode

08 Number of satellites being tracked

0.9 Horizontal dilution of position

545.4,M Altitude, Meters, above mean sea level
46.9,M Height of geoid (mean sea level) above WGS84 ellipsoid
(empty field) time in seconds since last DGPS update
(empty field) DGPS station ID number
*47 the checksum data, always begins with *

1.5 Other Messages

$ACCFLT ignore the coef param. Keep the hysteresis param.

$ACCCFG keep the range param (1^{st}), remove the other 3 (bandwidth, mode, wakeup). Those 3 would be completely gone.

$ACCSAM remove the coef param. (alternately the whole command could be removed).

$AUTOCFG rename to $AUTOCONFIG (too long?) and keep these 4 params:
<min samples>, <thresh>, <speed>, <lat thresh>at$autocfg=?

$AUTOCFG: (5-30),(25-100),(100-1000),(10-25),(0-1),(5-40),(5-50)

To enable streaming:
AT$ACCDBG=211,X
X is a bitmask:
X desc
1 enable raw data stream
2 enable LPF1 data stream
4 enable transformed data stream
8 enable LPF2 (MMA) and cal data stream
X=15 will enable all the data streams together

For replay (Started from reset):

AT$GPSCMD=0//stop GPS

AT$ACCDBG=15,0//stops ACC polling

AT$ACCDBG=250//init ACC filter

Feed the NMEA sentences

Speed Threshold

In one embodiment, for orientation, only samples of speed greater than 5 mph are used. This was chosen based on the concept that sampling location while the vehicle was on a sloped surface can cause vertical orientation errors to be introduced. LPF2 can be configured to provide a 3 dB point of about 1.5 hours of movement, or ˜2 hours of driving.

Lateral Data Collection

Determination of direction of travel can be done by accepting data only when travelling at greater than 25 mph, not changing heading, and decreasing speed. This basically detects braking events, and allows determination of the x axis. In order to speed up the initial orientation process, all samples collected while the vertical orientation is being determined can be stored and processed in batch.

Quality Indication

An optional field for quality, with sending of data on a preset threshold can also be included. Training mechanisms can also be defined, allowing for predictable convergence of the vertical and lateral axes. An example of a potential quality indication is:
For first 10,000 samples, quality=5 (training)
If GPS lost after 10,000 samples, qualty=4
If GPS has 2D lock, quality=3
If GPS is locked and>10K samples, quality=1
Send data options to<x, or without quality

Messages

1. PNWAC—

What is claimed is:

1. A method of orienting an accelerometer, comprises:
properly filtering accelerometer data;
selecting accelerometer/OBD data for vertical alignment;
selecting accelerometer/OBD data for horizontal alignment;
calculating an alignment matrix;
calculating an RMS deviation of the alignment matrix to determine accuracy of alignment;
using the aligned data to determine driver behavior (braking, turning, accelerating, . . . );
sending the aligned or unaligned data, with or without alignment accuracy to a server application on a periodic basis, or upon detection of specified driver behavior; and
continuously monitoring and fine tuning the alignment matrix based upon ongoing measurements.

2. A method for orienting an accelerometer, comprising:
using accelerometer data for calculations;
using permutations of OBD, GPS, accelerometer and gyro data to qualify data for use in determining orientation;
calculating vertical alignment based upon long term averages of a gravity vector;
calculating lateral alignment based upon sample collected during straight line acceleration and deceleration;
creating a rotation matrix based upon alignment buffers;
determining the quality of alignment by monitoring variation in the rotation matrix; and
using aligned data if the matrix quality is above a configurable threshold.

3. A method for orienting an accelerometer for a driver behavior device, the method comprising:
inserting accelerometer data in a lateral data buffer in order to determine a gravity vector based upon information from any one or more of the following:
inserting data in a vertical data buffer, based upon information from any one or more of the following: GPS heading change of less than a configurable amount; GPS speed change of greater than a configurable amount; OBD speed change of greater than a configurable amount; and/or gyro rotation of less than a configurable amount;
calculating a rotation matrix based upon the data stored in the lateral and vertical data buffers;
calculating a deviation of the rotation matrix, and if deviation is less than a configurable amount, allowing driver behavior monitoring.
